(19) United States
(12) Patent Application Publication
(10) Pub. No.: US 2019/0086345 A1
(43) Pub. Date: Mar. 21, 2019

(54) Advanced Ground Thermal Conductivity Testing

(71) Applicants: Richard A. CLEMENZI, Asheville, NC (US); Garen N. EWBANK, Fairview, OK (US); Judith A. SIGLIN, Asheville, NC (US); Geothermal Design Center Inc., Asheville, NC (US)

(72) Inventors: Richard A Clemenzi, Asheville, NC (US); Garen N Ewbank, Fairview, OK (US); Judith A Siglin, Asheville, NC (US)

(73) Assignee: Geothermal Design Center Inc., Asheville, NC (US)

(21) Appl. No.: 16/083,507

(22) PCT Filed: Mar. 9, 2017
(86) PCT No.: PCT/US17/21644

§ 371 Date: Sep. 9, 2018

Related U.S. Application Data
(60) Provisional application No. 62/305,907, filed on Mar. 9, 2016.

(51) Int. Cl. G01N 25/18; F24T 10/17; F24T 10/15; G01N 25/00

(52) U.S. Cl. CPC G01N 25/18; F24T 10/17; F24T 2010/53; G01N 25/005; F24T 2201/00; F24T 10/15

(57) ABSTRACT

A new device and method for more quickly and accurately performing a Thermal Response Test (TRT) to determine the Thermal Conductivity (TC) of the ground for use by a Geothermal Heat Pump (GHP) system. Existing TRT methods require testing for about 48 hours and require a very stable source of heat. This invention reduces the testing time required to under 24 hours and removes the requirement for a stable heat source, and thus will decrease the cost for TC testing and increase its use. Further, this new device and method provides more information about the thermal properties of the earth being tested than prior techniques.

### NOTICE

This invention was made under a CRADA (No. NFE-16-06144) between Geothermal Design Center Inc. and Oak Ridge National Laboratory operated for the United States Department of Energy. The Government has certain rights in this invention.

### BACKGROUND ART

U.S. Pat. No. 4,343,181—Poppendiek—Aug. 10, 1982

U.S. Pat. No. 8,005,640—Chiefetz, et al.—Aug. 23, 2011

U.S. Pat. No. 9,175,546—Donderici—Nov. 3, 2015

### TECHNICAL FIELD

This invention pertains to the field of Geothermal Heat Pumps and determination of Ground Thermal Conductivity.

### BACKGROUND OF THE INVENTION

A Thermal Response Test (TRT) is used to determine the Thermal Conductivity (TC) of the earth for Geothermal Heat Pump (GHP) systems. This TRT involves installation of a water loop, usually into a well bore, backfilling the area around the loop, heating the water in the loop, and recording the temperature of the outgoing and returning water as well as the heat rate and flow rates. The backfilling is often with a specifically engineered “grout” product the TC of which is also of importance in a GHP system.

Correctly determining TC is a critical requirement for designing a cost-effective and fully functional GHP loopfield. The current method requires extremely clean electric power to produce the heat input which is generally only available using a large diesel generator that is expensive to rent and operate. Further, current TRT requires approximately a full 48 hours or more of testing to achieve the results needed, although some (U.S. Pat. No. 8,005,640) have suggested TRT completion in less than 36 hours using heat pulses. All prior efforts expect a “known” heat rate which significantly limits the possible heat sources.

Typically, a TRT involves very stable electric power to heat fluid being circulated in a pipe loop installed into the ground, with constant monitoring and recording of the fluid supply and return temperatures and flow rate being the principal inputs for analysis. These are then graphed on a log(time) scale and a straight line fit in the final 24 hours is used to obtain the very important TC result. This existing method is reported to have a +1-15% accuracy, and field testing of multiple TRT's within a 2-block radius has confirmed the relatively low accuracy of the current method.

The second important and needed physical property of the ground is Heat Capacity (HC) which currently is only subjectively estimated from the drilling log based on the rock materials identified and reported. Thermal Capacity together with TC is used to generate a number for the “Thermal Diffusivity” of the ground which is an input into GHP loopfield design software. Sometimes “Diffusivity” is instead estimated directly from the well log leaving HC to be calculable if desired. (Note: Thermal Conductivity and Thermal Capacity are the only physical properties here, with Thermal Diffusivity being a calculated parameter based on those physical properties.)

Also, the existing TRT method completely ignores the data collected that is associated with the grouted borehole where the fluid pipe is installed. Thus it produces no useful output about the grout or borehole.

### DISCLOSURE OF INVENTION

The current TC analysis protocol has several limiting factors including a lack of mathematical dimensionality and the use of a log calculation on time. By depending on a single dimension curve fit (i.e., straight line) and further doing so after reducing resolution on the time axis by using a log scale, the current TC analysis absolutely eliminates any valid analysis with a varying heat power source. Further, no effort is made to empirically determine the critically important Thermal Capacity property of the ground, and data for the first ¼ of the test period is essentially discarded which precludes any confirmation of the installed loop pipe or grout.

The present invention introduces a new method for TRT using a multidimensional dynamic model-based and time-continuous analyses to 1) dramatically reduce the TRT period; 2) allow a fluctuating heat input; 3) dynamically determine when to terminate the TRT; 5) empirically determine ground HC, grout TC, and grout HC; 6) empirically confirm reported bore depth and pipe configuration; and 7) report the frequency and duration of anomalous thermal movements in the ground such as from ground water movement. By eliminating the requirement for extremely stable electric power, this new TRT device and method creates a much lower cost TC determination capability, and further provides for post installation determination of the same for a fully installed GHP borefield using building operational data.

This invention further increases the reliability/accuracy of the TC result by involving a higher resolution data collection protocol.

Several new methods are involved to obtain the improvements cited. One method is to mathematically model the pipe-grout-borewall-ground thermal system, gather the thermal response data, create a dynamic simulation based on the model with the measured actual heat input, and then perform a multidimensional correlation between the dynamic simulation and the collected data to determine the most likely grout and ground TC and HC parameters, and confirm other installation properties such as bore depth, bore diameter, and pipe size and configuration. This method of multidimensional correlation analysis involves experimentally adjusting the values to be determined until a “best fit” solution or set of “best fit” solutions are found. This approach is further automated.

Further additional data about the installed loop is collected to confirm correct length. And even further, information about varying strata in the ground may be collected, analyzed, and reported to explain observed variability within the loop under test and effective TC of the ground. By periodically pausing the heat input and loop flow just long enough for temperatures to settle and heat to stabilize around the pipe, the flow can then be restarted and a fast set of temperature measurements will yield zones of greater and lesser thermal conductivity along the geothermal loop. Additionally, information about known variations in the conditions surrounding the loop, such as variations in bore diameter, can be entered and modeled/simulated to add even greater precision to the results given.

One specific aspect of this invention is to eliminate the TC Testing dependence on clean electric power for heating the fluid in the pipe loop. This electric power is often provided by a portable generator. In this case, the efficiency of a generator is typically only about 30%, meaning only 30% of the heat value of the fuel is successively converted into electricity. By eliminating the “high quality electric only” TC Testing heat input requirement of current TRT methods, a much higher percentage of the heat value of each gallon of fuel can be used, thus reducing fuel use and cost. Further, additional heat input sources can be utilized such as direct fuel water heaters, solar water heaters, heat pumps, etc.

By reducing the cost of a GHP TRT, this advancement will increase TRT testing use and will thus improve the quality of GHP system design. Additionally, this new capability of after-the-fact completed GHP loopfield TRT testing with varying thermal input opens a new door for GHP system analysis and validation, possibly leading to new GHP loopfield learnings and design improvements.

Further, the level of sophistication of this new dynamic simulation approach to TRT enables two new levels of refinement not before considered.

This invention applies equally to any form of GHP loop system, whether vertical bore, horizontal bore, horizontal/trenched (many forms), pond, thermal pile, completed loopfields, etc. Vertical bore is used as the example for all matter herein, but is not meant to limit the applicability of this advanced approach.

A minimum time length Thermal Response Test accurately determining ground Thermal Conductivity (TC) can include a time-wise continuous computational means for determining TC and a computational means for determining when more testing is not needed where:
the time-wise continuous computational means for determining TC is a running average with a fixed interval on log(time) referenced recorded loop temperature data,
the time-wise continuous computational means for determining TC is a progressive average with a fixed starting point on log(time) referenced recorded loop temperature data,
the means for determining when more testing is not needed is when variation in the time-wise continuous TC determination drops below a desired threshold, and
variation in the time-wise continuous TC determination is used to predict degree of ground water movement.

### BRIEF DESCRIPTION OF DRAWINGS

The following is a very basic description of one possible embodiment of this invention as depicted in the Drawings.

FIG. 1 shows the simplified thermal zone layout associated with typical uses of the subject invention. Shown is #1 a typical “well bore” with a #6 loop pipe (down and up) inserted, #2 a typical “double loop” inserted, and #18 shows a typical “concentric pipe” inserted. While we only show this with “well bore” terminology, the exact same applies to all “loop” installation methods with just the nature of the various elements changing, such as grout and rock for a well bore, grout and soil for a horizontal bore, or just soil for a horizontal loop. In the basic bore model #1, we see #3 depicting the surrounding “earth” or soil, #4 showing the bore wall, #5 showing the grout that is outward from the #6 pipe and #9 being the grout inward from the #6 pipes. The #10 dividing point for these “inner” and “outer” grout zones is the #8 center of the pipes, although this boundary is not necessarily at the exact center of the pipes. The same two “zone” approach is used with differing loop pipe configurations for model simplicity. For the #17 concentric pipe, you can see that there is a #14 grout boundary, but it does not bisect any pipes.

FIG. 2 shows the refined and reduced “circuit equivalent” of what we have actually reduced to practice. The concept of a resistor-capacitor (R-C) “circuit equivalence” has been discussed before, but a key barrier to its reduction into practice has been reliance on standard “finite element” approaches to the number and connection of the “elements” which we call a “cell” (#8) in this figure. The “finite element” approaches are highly computational heavy, and are often run on super computers. We have found that significant simplification can be undertaken while still achieving the modeling accuracy sufficient to reduce the error from 15% to 5%, and we further expect to be able to reduce error with oversampling of the measured field data. In our model, we have even further simplified the #7 “bore” area as per FIG. 1, and slightly increasing the number of “cells” or elements of that area closest to the pipe may also yield more accuracy without unnecessary computational burden. In this figure, lines indicating paths of heat flow, resistors correspond to the TC of that element of the system, and capacitors correspond to the HC of that element. Standard industry formulas are used to convert between heat (e.g., BTU/hr or W) and temperature (e.g., ° C. or ° F.). In each time step, the amount of heat energy transferred is determined by the cell's corresponding TC and the temperature difference to the next cell, then that heat energy is “moved” from one cell to the next by reducing the temperature of the sending cell and increasing the temperature of the receiving cell using the standard formulas.

In our reduced model, we have eliminated the pipe entirely from the computation. Heat energy from the fluid #1 is transferred directly from out of the pipe indicated by diodes #2 and placed into heat storage as depicted by capacitors #3 for the “inner grout” and #4 for the “outer grout”. Only enough heat is transferred to the inner grout to match temperature with the outer grout, and energy moves between the inner and outer grout via resister #5 when a temperature difference exists between them. In the circumstances of a single “pipe” such as for a concentric pipe system, the “inner grout” is eliminated and all of the heat put into the system is transferred to the #4 “outer grout” storage element. Starting after the #4/#6 “outer grout” at the borewall #12 (could just be the first layer of soil for horizontal loops), the process repeats with each successive outward layer of earth is modeled as a #8 “cell” by a single resistor (#10 typ.) corresponding to the TC of the substance (grout/soil/rock) and a single capacitor (#9 typ.) corresponding to the HC of that layer of substance. Energy is moved for each time period which matches the time rate of the recorded field sample data.

FIG. 3 is a typical graphic output of measured #5 thermal data (upper 3 curves) and #6 heat input rate (lower curve) showing how the temperature of the fluid, and thus the ground, increases over #4 time as heat is input into the ground. The upper 3 curves are fluid in (#2 lower curve), fluid out (#1 upper curve) as when “heated”, and the average of those two (#3 center curve).

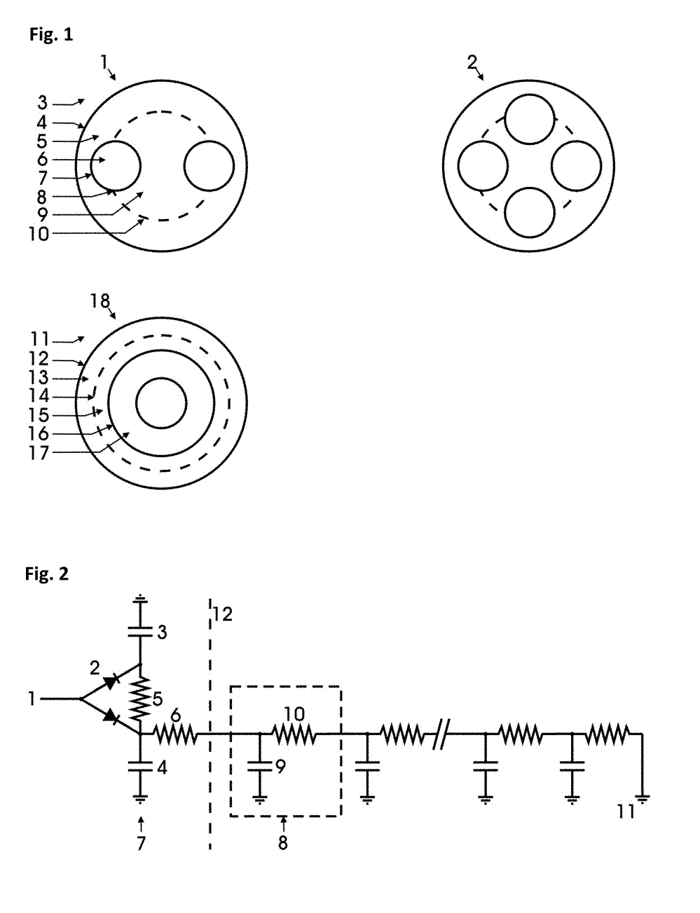

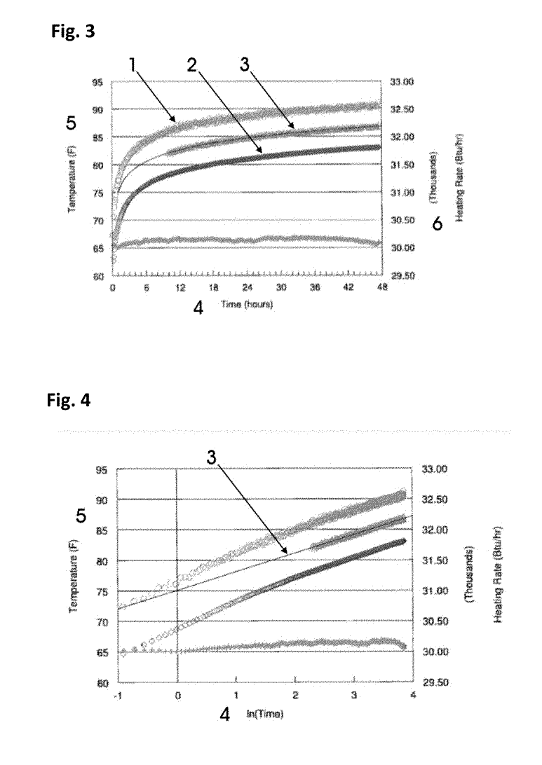

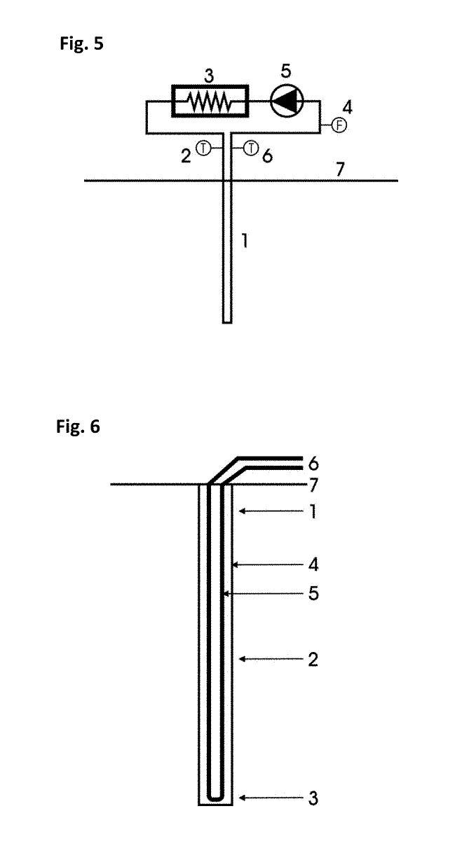

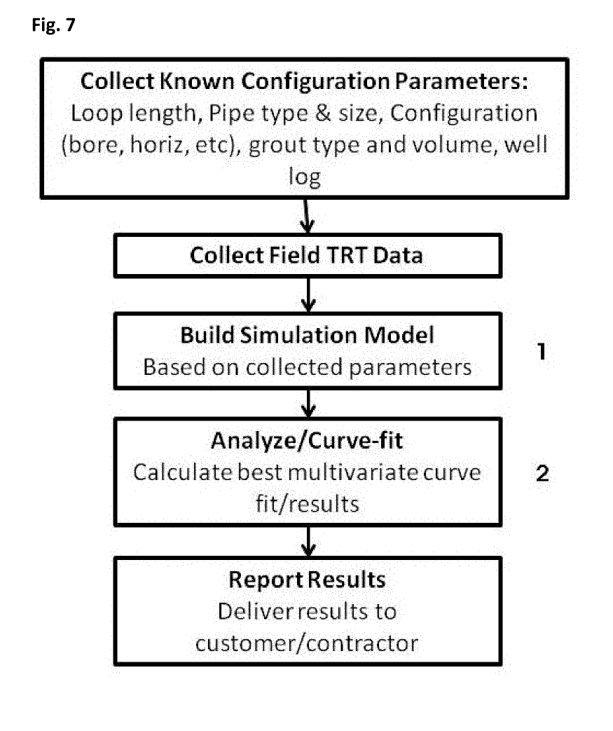

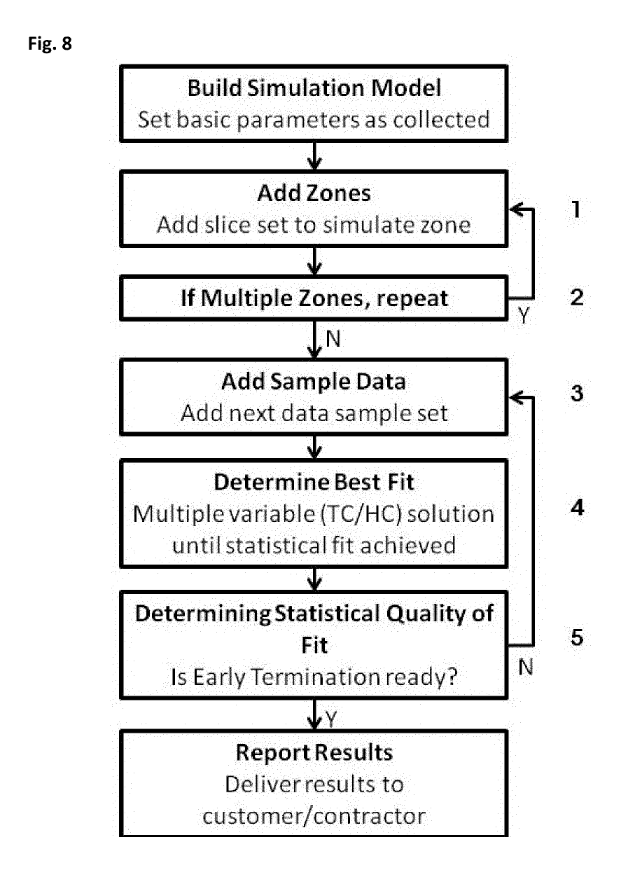

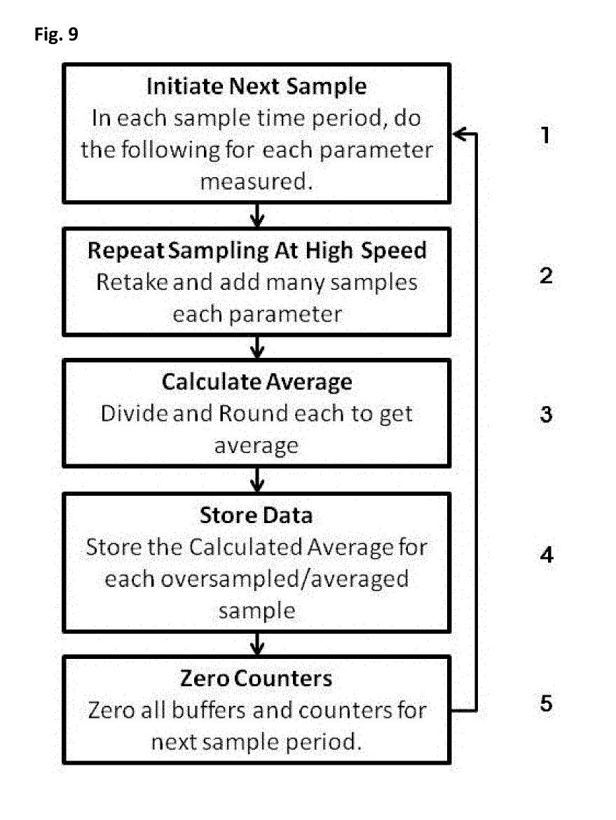

FIG. 4 shows how the existing TRT analysis is performed by fitting a #3 single dimension curve (straight line) to the #5 temperature data shown in FIG. 1, but with that data plotted on a #4 log(time) scale.

FIG. 5 shows the sub components associated with a TRT. Basically, there is a connection to the #1 loop under test inserted into the #7 ground, thermal sensors on both the #2 inlet and #6 outlet, a #5 circulator pump, #4 sensor(s) for determining flow rate, and a #3 heat input component. In the typical TC Test, the heat input component is an electric heater—usually an on-demand electric water heater, and the electricity is further accurately measured going into this water heater. This invention adds the option of also using other heat sources since we no longer require absolutely stable heat input. Thus, the #3 rectangular box showing an electric resistive element inside and labeled Heat Rate can instead take many forms, including CHP (combined heat and power), solar thermal, fuel thermal (e.g., propane water heater), etc.

FIG. 6 shows the typical thermal zones and layout of a typical #4 bore under test. The #6 tails of the #5 pipe loop at the top are above the #7 ground and are connected to the TRT apparatus. Shown are the basic zone areas from the surface to the bottom, with those zones having slightly different thermal responses and thus requiring different modeling. Not specifically identified is the grout back-fill that occupies all of the borehole volume outside the pipe loop. In every bore, there is an area #1 near the top which is typically soil and often has a larger bore diameter due to the drilling process, a #2 middle area which is generally homogenous, and a #3 bottom area where an accommodation must be taken into account for heat lost to the adjoining earth downward. This idea of “downward” or “upward” heat flow can be ignored everywhere except the #3 bottom.

FIG. 7 is the basic flow chart of the improved TRT method. The big difference here is the addition of the #1 “Build Simulation Model” and #2 “Analyze/Curve-Fit” steps with a multi-variable curve fit. These steps are new to this invention. Also the actual testing data is more advanced as we are both over-sampling and adding the optional acoustic testing for accurate loop length and flow rate.

FIG. 8 shows how the simulation model is built at the macro level. The complete dynamic simulation model process requires that each zone of earth (#1) along the loop path is added in repetition (#2). Then the process of integrating a TRT data sample (#3) is performed and a new “best fit” of the dynamic simulation model to actual data is performed (#4). After each sample is added and a new fit produced, a statistical test (#5) is performed and if the test is passed, then the TRT can terminate and a report be given to the user. Otherwise, the process is repeated at #3 “Add Sample Data” until the test is passed. This same process can be performed on an already completed TRT data set for post analysis without attempting to shorten the test.

FIG. 9 shows how oversampling is done to increase sample accuracy—this is a standard computer sampling method. Basically, the TRT method requires only 1-4 samples per minute so long as those samples are very high accuracy. However, there is always sample “jitter” or varying accuracy of each individual sample for a large number of reasons. To overcome this sample “jitter” and to thus obtain a very accurate sample, during the interval (#1) between samples a very large number of raw samples is taken and added together (#2). At the end of the interval, this figure is divided by the number of samples and rounded off (#3). Only that final “rounded average” is recorded (#4), and the counters are zeroed (#5) for the next sample period. Accuracy of the digital mathematics is essential for oversampling to be effective.

What is claimed:

1) An apparatus for conducting a Thermal Response Test and accurately determining ground Thermal Conductivity (TC), including:
a fluid loop inserted into the ground with circulating pump;
a heat source affecting the fluid loop that is not required to be stable;
a thermal sensor in the fluid loop with associated digital conversion and data recording;
a heat input sensor with associated digital conversion and data recording;
a dynamic simulation model of the fluid loop and surrounding area, and
a computational means for running the dynamic simulation and correlating it to the recorded data;
where the data recording and computational means are by computer with timestamp.

2) The apparatus in #1 where the heat source is a combination of electric and non-electric thermal energy sources.

3) The apparatus in #1 where the power source is only a non-electric thermal energy source.

4) The apparatus in #1 where heat input is solely from an electric source and the heat input sensor is a shunt for directly measuring heat input to the fluid via electric restive heating, with analog-to-digital conversion for computerized data recording.

5) The apparatus in #1 where the heat source is not solely electric and the heat input sensor is a combination of fluid temperature input and output sensors and a fluid flow sensor, with associated analog-to-digital conversion and digital computer input and recording, and the heat input to the fluid is computed from those inputs and recorded.

6) The apparatus in #1 where the dynamic simulation model is based on a simplified bore configuration model, concentric ground model, and time-wise movement of heat energy based on TC, distance, surface area, and Heat Capacity (HC) of each constituent element.

7) The apparatus in #1 where the dynamic simulation model can determine ground TC, grout TC, ground HC, grout HC, actual loop length, and actual loop pipe configuration from recorded heat input rate and loop temperature.

8) The apparatus in #1 where the method of correlation is to experimentally adjust the values to be determined to minimize “root mean squared” of the difference between the dynamic simulation model computed temperature and the measured fluid loop temperature.

9) The apparatus in #1 where the model allows for known variations in the conditions surrounding the loop pipe.

10) The apparatus in #1 where the following process is used to integrate information about variations in the rock strata into the model: a) a brief halt in heat input and loop pumping, b) pause for temperatures to stabilize, c) restart pump only, d) rapidly record temperature data for the first ½ loop's fluid, and e) restart full test process.

11) The apparatus in #1 where quality of the data is enhanced by oversampling and the data recording is an average of that oversampling.

12) The apparatus in #1 where TC and other properties are determined in under 24 hours.

13) The apparatus in #1 where the computational means is connected via a network.

14) An apparatus for conducting a minimum time length Thermal Response Test and accurately determining ground Thermal Conductivity (TC), including:
a fluid loop inserted into the ground with circulating pump;
a heat source affecting the fluid loop;
a thermal sensor in the fluid loop with associated digital conversion and data recording;
a heat input sensor with associated digital conversion and data recording;
the thermal and heat input sensors include any necessary analog-to-digital conversion and data is recorded by a computer at a specified time rate per sample;
a time-wise continuous computational means for determining TC; and
a computational means for determining when more testing is not needed;
where the data recording and computational means are by computer with timestamp.

15) The apparatus in #14 where the quality of the data is enhanced by oversampling and the data recording is an average of that oversampling.

16) The apparatus in #14 where the time-wise continuous computational means for determining TC is a running average with a fixed interval on log(time) referenced recorded loop temperature data.

17) The apparatus in #14 where the time-wise continuous computational means for determining TC is a progressive average with a fixed starting point on log(time) referenced recorded loop temperature data.

18) The apparatus in #14 where the means for determining when more testing is not needed is when variation in the time-wise continuous TC determination drops below a desired threshold.

19) The apparatus in #14 where variations in the time-wise continuous TC determination is used to predict degree of ground water movement.

20) The apparatus in #14 where the computational means is connected via a network.

21) An apparatus for conducting a Thermal Response Test and accurately determining ground Thermal Conductivity (TC), including:
a fluid loop inserted into the ground with circulating pump;
a heat source affecting the fluid loop that is not required to be stable;
a thermal sensor in the fluid loop with associated digital conversion and data recording;
a heat input sensor with associated digital conversion and data recording;
a dynamic simulation model of the fluid loop and surrounding area,
a computational means for running the dynamic simulation and correlating it to the recorded data;
a time-wise continuous computational means for determining TC; and
a computational means for determining when more testing is not needed;
where the data recording and computational means are by computer with timestamp.

22) The apparatus in #21 where the dynamic simulation model can determine ground TC, grout TC, ground HC, grout HC, actual loop length, and actual loop pipe configuration from recorded heat input rate and loop temperature.

23) The apparatus in #21 where the time-wise continuous computational means for determining TC is a smoothed running average on log(time) referenced recorded loop temperature data.

24) The apparatus in #21 where the time-wise continuous computational means for determining TC is a progressive average with a fixed starting point on log(time) referenced recorded loop temperature data.

25) The apparatus in #21 where the means for determining when more testing is not needed is both 1) when variation in the time-wise continuous TC determination drops below a desired threshold and 2) correlation between the experimentally resolved dynamic simulation model computed temperature and the measured fluid loop temperature is achieved beyond a desired level of statistical significance.

26) The apparatus in #21 where the computational means is connected via a network.
